(19) United States
(12) Patent Application Publication
(10) Pub. No.: US 2010/0243633 A1
(43) Pub. Date: Sep. 30, 2010

(54) Power Line De-Icing Apparatus

(76) Inventors: Tung Huynh, North Andover, MA (US); Alyssa Baotram Huynh, North Andover, MA (US); Anthony Minhtruong Huynh, North Andover, MA (US)

Correspondence Address: Daniel N. Smith, One Salem Green, Suite 500, Salem, MA, 01970, US

(21) Appl. No.: 12/730,002

(22) Filed: Mar. 23, 2010

Related U.S. Application Data
(63) Continuation-in-part of application No. 12/410,041, filed on Mar. 24, 2009.

(51) Int. Cl. H05B 1/00

(52) U.S. Cl. 219/209

(57) ABSTRACT

A power line de-icing apparatus that incorporates both thermal and mechanical means to remove various forms of accumulated ice or wet snow from power lines. The apparatus uses a minimum amount of energy to first de-bond and then break off ice from the power line; using far less power than required to fully melt ice. The apparatus operates autonomously, activating heating and chisel mechanisms, and moving between power line support towers in response to both temperature and ice sensor inputs. This operation is repeated in both directions along the power line as long as icing continues to activate the sensors; removing ice more quickly than it can accumulate and thereby preventing mechanical or electrical damage to the power lines and supporting towers. The apparatus is self contained and powered inductively from the power line. It is installed onto the power line without the need for disconnecting the power line.

### CROSS REFERENCE TO RELATED APPLICATION

This application is a continuation-in-part and claims priority to U.S. patent application Ser. No. 12/410,041 filed on Mar. 24, 2009, the contents of which are incorporated herein by reference.

### FIELD OF THE INVENTION

This invention relates to a novel apparatus for de-icing power lines.

### BACKGROUND OF INVENTION

Ice and wet snow can accumulate on power transmission lines during ice storms. Given the right conditions, this accumulation can apply significant additional weight and make the lines more susceptible to wind induced oscillation. Sufficient accumulation can cause the conductors to contact each other; break or detach from the supporting structures; and, in extreme cases, cause the collapse of the transmission towers—resulting in wide spread power interruptions. While it is possible to physically break accumulated ice off the lines, this is a time consuming and dangerous process—particularly when icy conditions complicate access to the lines by air or ground. In addition, utility company manpower is typically needed to repair lower voltage distribution lines damaged by broken tree limbs to restore power to residential and commercial properties.

A number of methods for de-icing power transmission lines using electrical currents have been explored. The “Joules” method is based on the transmission of higher than normal electric currents or an outside power source to generate additional heat in the transmission line to melt any ice or snow buildup. This method has the disadvantage of either requiring power service interruption for several hours or requiring the addition of expensive external power sources. For example, U.S. Pat. No. 6,018,152, Allaire & LaForte, disclose a method to redirect an electric current carried by a bundle of conductors into a single conductor in order to heat the transmission line. U.S. Pat. No. 6,727,604, Couture, discloses a switching apparatus to short circuit transmission phases and drives enough electric current to heat the transmission lines. U.S. Pat. No. 4,082,962, Burgsdorf et al.; and U.S. Pat. Nos. 4,085,338, 4,119,866, 4,126,792 and 4,135,221 all by Genrikh et al., outline various approaches to using High Voltage DC current to remove ice or snow from transmission lines. A number of thermal techniques for de-icing power transmission lines have also been explored. These methods have the disadvantage of requiring the construction of redesigned power line cables or additional power supplies. For example, U.S. Pat. No. 2,870,311, Greenfield et al. disclose an electrical cable structure that contains an inner conductor and an outer conductor separated by an insulating material. When ice forms on these cables, a strong electric current is passed through the outer conductor to cause it to increase in temperature, thereby melting the ice on the cable. U.S. Pat. No. 3,316,344, Kidd et al., and U.S. Pat. No. 3,316,345, Toms et al., disclose an electrical cable structure with an exterior composed of a magnetic material. When the outside temperature falls below a given range, this magnetic material allows more electric current to pass through, thereby causing the material to increase in temperature and melt any ice on the cable. U.S. Pat. No. 7,138,599, Petrenko discloses a means of de-icing power lines by using the high AC voltage generated by the power lines. In this method, an outer shell is fabricated or wrapped around power lines to form a hollow layer between the outer shell and the power line. This hollow layer is filled with gases that absorb electrical energy from alternating electric fields generated by the power lines. As these gases absorb electrical energy, the gases form heat-generating plasma within the hollow layer that causes any ice on the outer layer to melt.

Various mechanical methods for de-icing power transmission lines have also been attempted. U.S. Pat. No. 3,835,269, Levin et al. disclose a device for de-icing a power line by generating electromagnetic pulses on the line. The device is installed in close proximity to the power line and transported along the line by a vehicle on the ground. U.S. Pat. No. 4,212,378, Hrovat discloses a device for de-icing power lines consisting of wheeled dollies mounted on a line. These devices have scrapers for removing ice from the line. U.S. Pat. No. 5,411,121, LaForte et al. disclose a device for de-icing power lines that includes one pair of conductive wires connected to and helically wound along the lines. The conductive wires are connected to a pulsing device that generates an electromagnetic pulse within the wires that creates a repulsive force between the wires, thereby shaking the wires and shattering the ice that may be attached to the power line.

None of the above inventions disclose an effective and inexpensive apparatus that can be set to automatically de-ice power lines during ice storms with minimal power consumption and supervision. The apparatus of the present invention provides a unique solution to maintaining the integrity of power lines during ice storms without interrupting service or adding complex and unreliable hardware.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an apparatus for de-icing power lines. The apparatus comprises two similar sections, such that the apparatus is symmetrical at the center of its length. The apparatus resides on the power line and can move along the power line in either direction. The apparatus uses both thermal and mechanical means to efficiently remove various forms of ice or wet snow from a power line. By using a relatively small amount of heat applied to the bare power line within the apparatus, the bond between accumulated ice and the power line immediately outside the apparatus is quickly broken; replaced by a thin water layer between the ice sheath and underlying power cable. This weakens the ice layer to the point that simple impact by a chisel mechanism can quickly and easily shatter and thereby remove the ice from the power line.

For clarity of the description, components associated with the forward direction are called “first” and the components associated with the trailing direction are called “second”.

One embodiment of the subject invention is an apparatus for de-icing a power line, the apparatus comprising: a housing comprising a first opening and a second opening, wherein the housing is placed over the power line such that a portion of the power line is contained within the housing and extends through both openings; a means for moving the housing in either direction along the power line; a first heating element proximate to the first opening, wherein the first heating element generates sufficient heat to the external surface of the power line proximate to the first opening to substantially melt the layer of ice attached to the external surface of the power line; a first chisel member proximate to the first opening, wherein the first chisel member removes ice with the substantially melted attached layer from the power line; a second heating element proximate to the second opening; wherein the second heating element provides generates heat to the external surface of the power line proximate to the second opening to substantially melt the layer of ice attached to the external surface of the power line; a second chisel member proximate to the second opening, wherein the second chisel member removes ice with the substantially melted attached layer from the power line; and an electronics system disposed within the housing. In embodiments of the subject invention, the layer of ice attached to the external surface of the power line adheres to, has surface friction with, or interfaces with the external surface of the power line.

Another embodiment of the subject invention is an apparatus for de-icing a power line, the apparatus comprising: a hollow housing comprising two openings, wherein the housing is placed over the power line such that a portion of the power line is contained within the housing and extends through both openings; a means for moving the housing in either direction along the power line; a motor operably connected to the means for moving the housing; a temperature sensor attached to the housing; an ice sensor attached to the housing; a first heating element and a first proximity sensor disposed on the housing proximate to one of the openings; a second heating element and a second proximity sensor disposed on the housing proximate to the other opening; and an electronics system disposed within the housing.

A further embodiment of the subject invention is an apparatus for de-icing a power line, the apparatus comprising: a housing; an internal hollow channel traversing the housing from a first opening on a first end of the housing to a second opening on a second end of the housing, wherein the housing is placed over the power line such that a portion of the power line is contained within the internal hollow channel and extends through the first opening and the second opening; a first rotatable wheel contained within the housing proximate to the first opening, wherein the first rotatable wheel engages the power line for rolling movement therealong; a second rotatable wheel contained within the housing proximate to the second opening, wherein the second rotatable wheel engages the power line for rolling movement therealong; at least one drive motor contained within the housing, wherein the motor is operably connected to the rotatable wheels; a temperature sensor attached to the housing; an ice sensor attached to the housing; a first plurality of heating elements attached to the housing proximate to the first opening, wherein the first plurality of heating elements operably provide heat to the enclosed power line proximate to the first opening and an exterior portion of the housing proximate to the first opening; a second plurality of heating elements attached to the housing proximate to the second opening, wherein the second plurality of heating elements operably provide heat to the enclosed power line proximate to the second opening and an exterior portion of the housing proximate to the second opening; a first proximity sensor attached to the housing proximate to the first opening; a second proximity sensor attached to the housing proximate to the second opening; a first power transformer contained within the housing proximate to the first opening; a second power transformer contained within the housing proximate to the second opening, wherein either the first or second power transformer generates electrical power for the apparatus from electric current carried by the power line; and an electronics system contained within the housing; wherein the electronics system is operationally connected to the drive motor, temperature sensor, ice sensor, motion sensor, pluralities of heating elements, proximity sensors, and power transformers.

The heating elements of the subject invention provide heat to the power line in order to melt a superficial layer of ice that is in direct contact with the power line; only one heating element is in operation at any given time depending upon the direction of travel on the power line.

The chisel mechanism at the first opening starts to work at the same time as the first heating element and the chisel mechanism at the second opening starts to work at the same time as the second heating element. Each chisel has limited mobility to avoid physical contact with the power line.

In embodiments of the subject invention, the electronics system contained within the housing includes means for regulating power, distributing power, interfaces for all sensors and control functions

In one embodiment of the subject invention, an internal hollow channel comprises an inverted substantially U shaped configuration, thereby allowing the device to be installed over the hanging power line without disconnecting the power line.

In another embodiment of the subject invention, the apparatus further comprises various types of line spacers to replace existing ones on the power line. These line spacers elevate the power line above the mechanical braces such that the inverted substantially U shaped configured hollow channel of the apparatus can move past the spacers without being blocked.

In another embodiment of the subject invention, the apparatus further comprises two line spacer detectors, one on each end, to detect power line spacers. In a further embodiment of the subject invention, the housing further comprises a two half covers that each open to the internal hollow channel, wherein the half covers are substantially equivalent in size and shape. In an additional embodiment of the subject invention, the housing further comprises two internal cover motors for opening and closing the half covers. These internal cover motors are each able to open and close each half cover independently to aid the apparatus in moving past line spacers on the power line.

In one embodiment of the subject invention, a motor rotates the rotatable wheels in either direction along the line. In another embodiment of the subject invention, the apparatus further comprises two sets of balance wheels, one set on each half cover, that engage the power line within the internal channel and help stabilize the apparatus as it moves along the power line.

In another embodiment of the subject invention, the apparatus further comprises a motion sensor contained within the housing, wherein the motion sensor is proximate to the internal hollow channel for detecting movement along the power line. This motion sensor comprises an optical encoder or is selected from the group consisting of ultrasonic, optical, microwave, and video motion detectors.

In another embodiment of the subject invention, the apparatus further comprises at least two physically separate end-of-line or stop members affixed to the power line at the extreme ends of desired apparatus travel. These members delineate the range of travel for the apparatus along the power line.

In a further embodiment of the subject invention, the first proximity sensor and the second proximity sensor are selected from the group consisting of pressure, electromagnetic, proximity, ultrasonic and optical sensors.

In another embodiment of the subject invention, the temperature sensor is selected from the group consisting of infrared, optical pyrometer, fiber optic thermometer, an acoustic meter, an ultrasonic meter, thermocouples, bimetallic elements, temperature probes or a heat sensor.

Another embodiment of the subject invention is method for de-icing a hanging power line comprising the steps of: a) attaching an apparatus comprising a housing to the power line, wherein the power line extends through a first opening and a second opening on the housing; b) generating electric power for the apparatus from electric current carried by the power line; c) detecting an ambient temperature below 35° F.; d) detecting ice formed on an ice sensor attached to the housing, wherein a pre-determined amount of ice formed sends an activating signal to an electronics system attached to the housing; e) activating a first heating element attached to the housing proximate to the first opening, wherein the first heating element provides sufficient heat to the external surface of the power line proximate to the first opening to substantially melt the layer of ice attached to the external surface of the power line; f) activating a first chisel member attached to the housing proximate to the first opening, wherein the first chisel member removes ice with the substantially melted attached layer from the power line; g) activating a means for moving the apparatus in a first direction such that the first opening moves substantially forward along the power line and the second opening moves substantially backward along the power line, further wherein the first heating element and the first chisel member are operating in the first direction to remove ice from the power line; h) detecting a first stop member with a first proximity sensor attached to the housing; i) de-activating the means for moving the apparatus in the first direction, the first heating element and the first chisel member; j) activating a second heating element attached to the housing proximate to the second opening, wherein the second heating element provides sufficient heat to the external surface of the power line proximate to the second opening to substantially melt the layer of ice attached to the external surface of the power line; k) activating a second chisel member attached to the housing proximate to the second opening, wherein the second chisel member removes ice with the substantially melted attached layer from the power line; l) activating a means for moving the apparatus in a second direction such that the second opening moves substantially forward along the power line and the first opening moves substantially backward along the power line, further wherein the second heating element and the second chisel member are operating in the second direction to remove ice from the power line; m) detecting a second stop member a second proximity sensor attached to the housing; n) de-activating the means for moving the apparatus in the second direction, the second heating element and the second chisel member; and o) repeating steps e) through i) above if ice is detected on the ice sensor, otherwise docking at the second stop member if no ice is detected.

The subject invention also discloses another method for de-icing a hanging power line comprising the steps of: a) attaching an apparatus comprising a housing over the power line without interruption by placing the power line within an internal hollow channel traversing the housing such that the power line extends through a first opening and a second opening in the housing, and further that the power line engages two rotatable wheels contained within the housing; b) allowing the apparatus to generate internal electric power from current carried in the power line using two current transformers contained within the housing; c) allowing the apparatus to automatically close two substantially equivalent half covers over the internal hollow channel such that the rotatable wheels engage the power line; d) detecting ambient temperature with a temperature sensor attached to the housing, wherein a detected temperature below 35° F. sends a first signal from the temperature sensor to an electronics system contained within the housing; e) detecting ice formed on an ice sensor attached to the housing, wherein a pre-determined amount of ice sends a second signal to the electronics system; f) activating an ice sensor heating element to provide heat to the ice sensor to melt accumulated ice thereon; g) activating a first plurality of heating elements attached to a first side of the housing that is moving forward in the first direction, thereby melting a thin layer of ice at the surface of the power line immediately inside and proximate to the first opening; h) activating a first plurality of chisel members attached to the first side of the housing that is moving forward in the first direction, which begins removing ice that has been heated and de-bonded from the power line; i) activating a drive motor contained within the housing, wherein the drive motor operates the rotatable wheels to move the apparatus along the power line in the first direction; j) detecting a first end-of-line member affixed to the power line with a first proximity sensor attached to the first side of the housing and sending a third signal to the electronics system; k) de-activating the drive motor, the first plurality of heating elements and the first plurality of chisel members; l) if required, again detecting ice formed on the ice sensor attached to the housing, wherein the pre-determined amount of ice sends a fourth signal to the electronics system, further wherein if ice is detected on the ice sensor then activating the drive motor to operate the rotatable wheels, wherein the rotatable wheels move the apparatus along the power line in a second direction (otherwise docking at the first stop member if no ice is detected); m) activating a second plurality of heating elements attached to a second side of the housing that is moving forward in the second direction, thereby melting a thin layer of ice at the surface of the power line immediately inside and proximate to the second opening; n) activating a second plurality of chisel members attached to the second side of the housing that is moving in the second direction, which begins removing ice that has been heated and de-bonded from the power line; o) detecting a second end-of-line member affixed to the power line with a second proximity sensor attached to the second side of the housing and sending a fifth signal to the electronics system; p) de-activating the drive motor, the second plurality of heating elements and the second plurality of chisel members; q) detecting ice formed on the ice sensor attached to the housing, wherein the pre-determined amount of ice sends a sixth signal to the electronics system; and r) repeating steps e) through l) above if ice is detected on the ice sensor, otherwise docking at the second end-of-line member if no ice is detected.

In one embodiment of the subject invention, the apparatus comprises first and second pluralities of spacer detectors attached to the housing. During the de-icing operation, when the apparatus approaches a line spacer on the power line, the first plurality of spacer detectors at the first side of the apparatus will send a signal to the electronics system to activate the first cover motor to open the first half cover. This operation will move the first set of rotatable wheels and a bottom “I” core of the first transformer out of the way so that the line spacer may pass through the internal hollow channel of the apparatus. Once the line spacer has passed the first set of rotatable wheels, the first plurality of spacer detectors will send another signal to the electronics system to activate the first cover motor to close the first half cover. This operation will return the first set of rotatable wheels and the bottom “I” core of the first transformer to their original positions.

Very soon after, as the apparatus keeps moving along the power line in a given direction, the line spacer will approach the second set of rotatable wheels. The second plurality of spacer detectors will then send a signal to the electronics system to activate the second cover motor to open the second half cover. This operation will move the second set of rotatable wheels and a bottom “I” core of the second transformer out of the way so that the line spacer may pass through the apparatus. Once the line spacer has passed the second set of rotatable wheels, the second plurality of spacer detectors will send another signal to the electronics system to activate the second cover motor to close the second half cover. This operation will return the second set of rotatable wheels and the bottom “I” core of the second transformer to their original positions.

In another embodiment of the subject invention, the apparatus further comprises a remote control receiver and transmitter for a user interface operationally connected to the electronics system. In another embodiment of the subject invention, the electronics system further comprises an internal programmable microprocessor and a control program. In a further embodiment of the subject invention, the electronics system is connected to both power transformers to receive, regulate and supply electric power for the operation of the apparatus. In a further embodiment of the subject invention, the motors are connected to the electronics system to receive electric power and signals for operation. In another embodiment of the subject invention, the ice sensor is connected to the electronics system to receive electric power and signals for operation. In one embodiment of the subject invention, the temperature sensor is connected to the electronics system to receive electric power and sends signals back to the electronics system. In another embodiment of the subject invention, the first and second proximity sensors are connected to the electronics system to receive electric power and send signals to the electronics system. In one embodiment of the subject invention, the first and second pluralities of heating elements are connected to electronics system to receive electric power and signals for operation.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated embodiments of the invention. Other features and advantages of the present invention will become apparent from the following description of the embodiment(s), taken in conjunction with the accompanying drawings, which illustrate, by way of example, the principles of the invention.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a longitudinal cross-sectional view of the de-icing apparatus on the power line.

FIG. 2 illustrates a side view of the de-icing apparatus in the operational position along the axis of the power line.

FIG. 3 illustrates a top view of the de-icing apparatus on the power line.

FIG. 4 illustrates another side view of the de-icing apparatus in the installation position, along the axis of the power line.

FIG. 5 illustrates a side view of the de-icing apparatus in half-open position as it passes through a line spacer, along the axis of the power line.

FIG. 6a illustrates a front view of line spacers for a double power line bundle.

FIG. 6b illustrates a front view of a line spacer for a triple power line bundle.

FIG. 6c illustrates a front view of a line spacer for a quadruple power line bundle.

### DETAILED DESCRIPTION OF THE PREFERRED EMBODIMENTS

While several variations of the present invention have been illustrated by way of example in particular embodiments, it is apparent that further embodiments could be developed within the spirit and scope of the present invention, or the inventive concept thereof. It is to be expressly understood that such modifications and adaptations are within the spirit and scope of the present invention, and are inclusive, but not limited to the following appended claims as set forth.

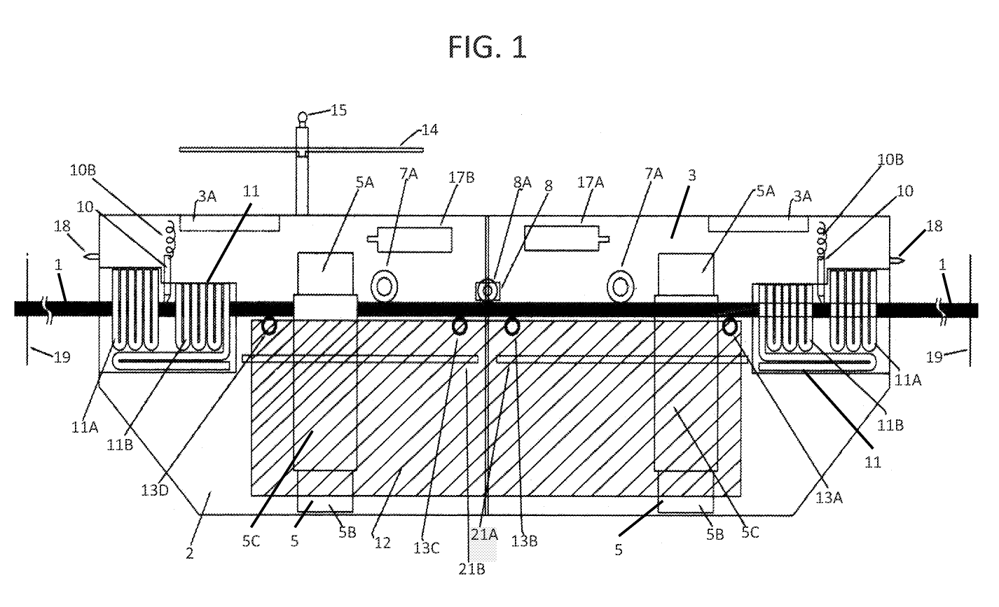

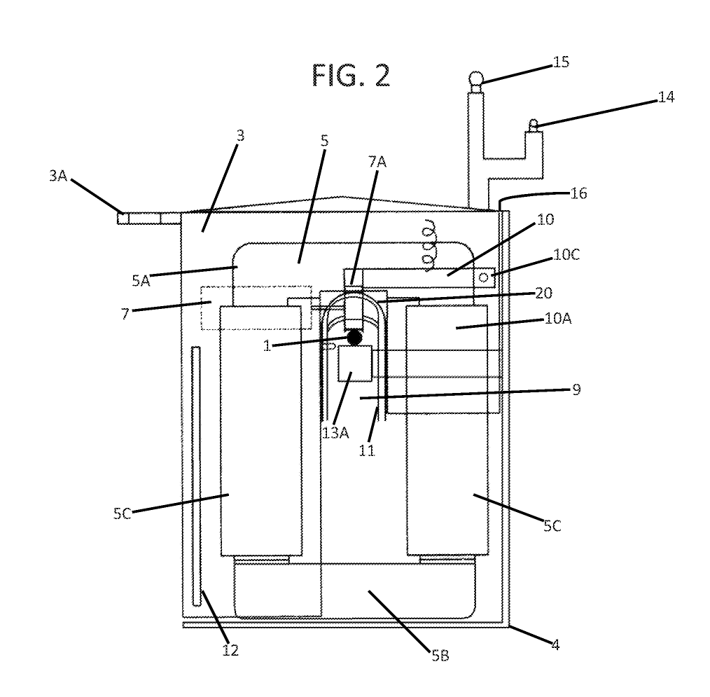

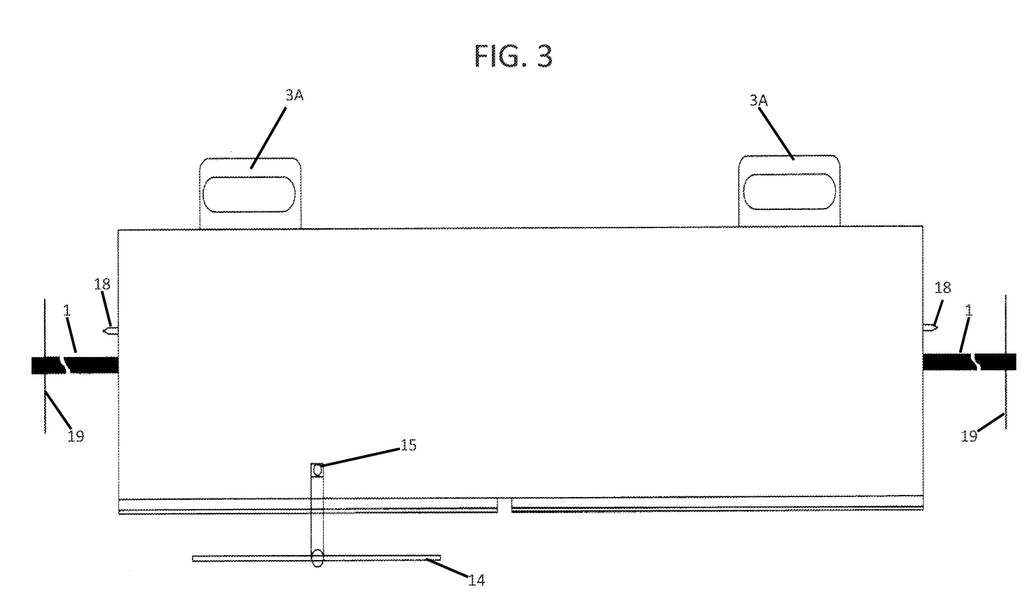

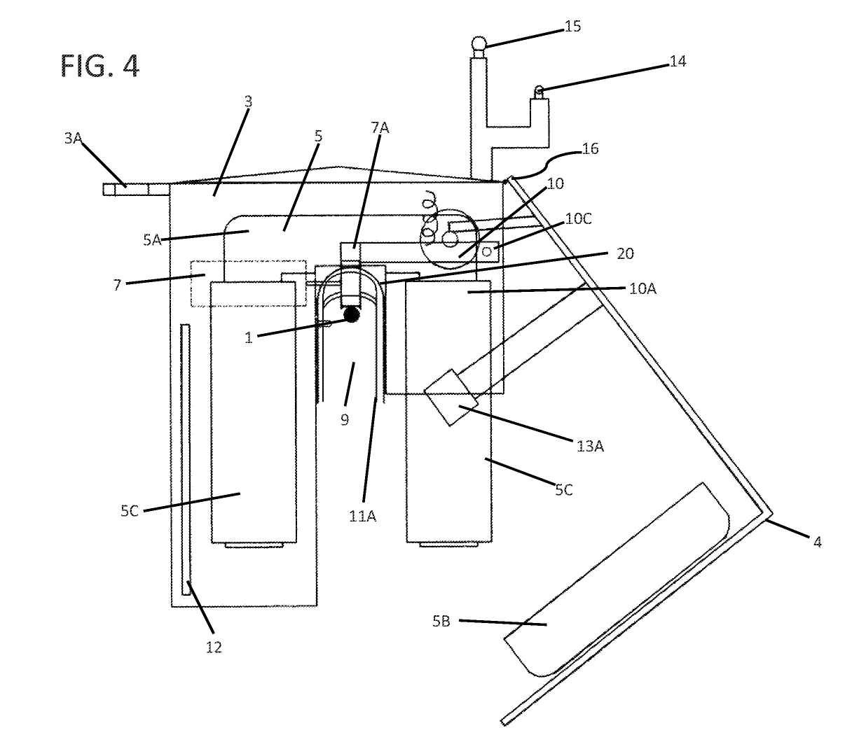

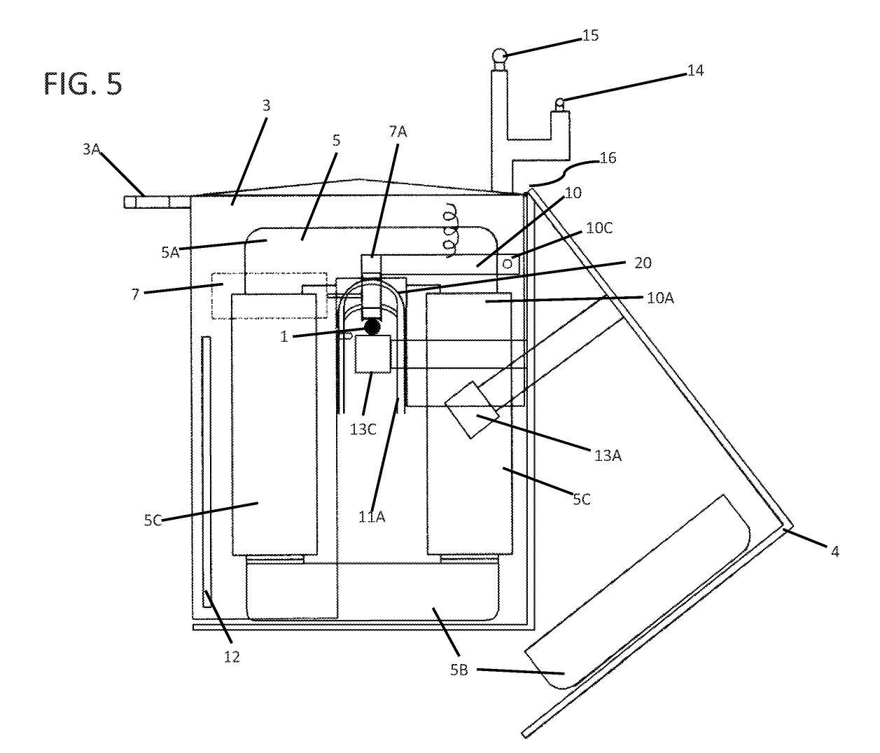

FIGS. 1, 2 and 3 illustrate an embodiment of the subject invention that comprises an apparatus 2 with built-in heaters 11a & 11b and chisels 10 for de-icing an ice-covered power line 1. The apparatus 2 comprises a housing 3 and a split cover 4. A hinge 16 connects the housing 3 and the split cover 4. In one embodiment of the subject invention, the hinge 16 is a mechanical hinge that secures the split cover 4 to the housing 3. Each half of the split cover 4 can be locked tight over the housing 3 or opened by the separate cover motors 17a and 17b. In one embodiment of the subject invention, the split cover 4 comprises two nearly identical “L” shaped configurations that are hinged to the housing 3 on the top corner. In one embodiment of the subject invention, the cover 4 may be locked to the housing 3 with a magnetic lock (not shown).

The housing 3 comprises a hollow traverse channel 9 for containing the power line 1. In one embodiment of this subject invention, this channel 9 comprises an upside down or inverted “U” shaped configuration. The housing 3 also comprises two transformers 5 that use the power line 1 as their primary winding to generate electric power on secondary windings contained within bobbins 5C for use within the apparatus 2. These are current transformers and thus the output current is equal to the current on the power line 1 divided by the number of turns on the secondary windings. The raw power generated by the transformers 5 is proportional to the current on the power line 1. Part of the electronics system 12 is used to regulate power from each transformer to both accommodate different levels of steady state and transient current in power line 1 and to fulfill the power requirements for different modes of operation of the apparatus.

Each of the transformers 5 consist of an inverted “U” shaped core 5A, an “I” shaped core 5B and two bobbins 5C, one on each leg of the “U” shaped core 5A. When the cover 4 closes, the “I” shaped cores 5B connect to the “U” shaped cores 5A to close the magnetic paths for the transformers 5. All cores 5A and 5B are made of magnetic material such as silicon steel or ferrite. In one embodiment of this subject invention, both transformers 5 are used to power the whole apparatus 2, but either one is capable of supplying enough power for the operation when one of the half covers 4 opens to go over a line spacer. In stand-by mode, only one of the transformers 5 is operating.

In one embodiment of this subject invention, the motor 7 is a geared motor that can operate in both directions along the power line 1, forward and reverse. The motor 7 provides torque to drive one or two drive wheels 7A that rest on and engage power line 1 within the hollow traverse channel 9 of housing 3 to roll the apparatus in both directions, forward and reverse, along the power line 1.

In one embodiment if the subject invention, each half of the cover 4 contains a set of two balance wheels 13A, 13B, 13C and 13D that push themselves upwards against the power line 1 when the cover 4 is closed and thus pull the apparatus 2 downwards against the power line 1. The forces from the balance wheels 13A, 13B, 13C and 13D against the power line 1 will cause more pressure between the drive wheels 7A and the power line 1 for more traction.

The apparatus 2 may further comprise one or more internal motion sensors for detecting movement along the power line 1. In different embodiments of the subject invention, this motion sensor may be contained within one of the driving wheels 7A, one of the balance wheels 13A, 13B, 13C and 13D or be a separate sensor.

In one embodiment of the subject invention, the motion sensor comprises an optical encoder 8 which generates electronic signals based on angular movement of its shaft. The shaft is connected to an encoder wheel 8A which rests on the power line 1. Once the apparatus 2 is moved on the power line 1 by the drive motor 7 and drive wheels 7A, the encoder wheel 8A will roll on the power line 1 and thus generate angular movement. This angular movement is translated by the encoder 8 to an electrical signal for the electronics system 12 to process.

In another embodiment of the subject invention, the motion sensors may comprise a motion sensor selected from the group consisting of ultrasonic, optical, microwave, and video motion detectors. It will be understood that the sensors could be implemented with a variety of sensing technologies for a variety of ambient conditions. All such variations come within the spirit and scope of the present invention.

The housing further contains two chisels 10 which are two dull “V” shaped steel blades with fulcrums 10C at a distal end. Each chisel 10 is attached to a spring 10B at a proximal end to pull each of them up to clear the power line 1. Each chisel 10 is driven by a solenoid 10A which will magnetically pull the steel blades down toward, but not touching, the power line 1. The solenoids 10A pull the steel blades down at a high velocity, several times per second, to fracture and remove ice from the power line 1 after the ice has been partially heated and de-bonded from the power line 1. The chisel shape, material, angle of impact and speed of impact are selected to optimize removal of the various forms of ice and wet snow that may accumulate on the power line 1. The travel of the chisel blade will be limited by an adjustable or fixed stop mechanism to prevent blade contact with the power line 1 while maintaining the correct spaced gap between the blade and power line for effective ice removal.

Heaters 11 of the apparatus 2 also have an inverted “U” shaped configuration to conform to the traverse channel 9 in the same manner as housing 3 and transformers 5. Heaters 11 are designed in two sections 11A and 11B, each made of common heating elements. The first section of the heaters 11A, is located on both ends of apparatus 2. Heater section 11A has a large gap between the heating elements and the power line 1 to accommodate the accumulation of ice attached to the power line 1. As the motor 7 drives the drive wheels 7A to move the apparatus 2 along the power line 1 in a given direction, the heater section 11A and chisel 10 in that same given direction begin to heat and chip at any ice attached to the power line 1. The primary method of removing accumulated ice comes about from heater section 11B heating the bare power line 1 within the apparatus 2. This heat is rapidly conducted outward from the heater and along the bare power line 1 where it serves to melt a small amount of the accumulated ice in front of the apparatus 2 at the interface between the power line 1 and accumulated ice sheath. This will create a thin layer of liquid between the power line 1 and the accumulated ice, thereby weakening the bonding of the accumulated ice sheath to the power line 1. In this weakened de-bonded state, it becomes relatively easy for the chisel 10 to break off the accumulated ice from the power line 1, whereupon the broken off ice falls out of the bottom of the “U” shaped channel 9 and out of the bottom cover 4 to the ground below.

Heater section 11A assists in weakening the bond of the accumulated ice to the power line 1 and melts the outer diameter of any accumulated ice sheath that has built up a diameter too large to fit inside the apparatus 2, thereby reducing this ice sheath diameter. As the apparatus 2 moves along the power line, any remaining ice on the power line 1 that is not fully removed will block movement of one of the balance wheels 13A, 13B, 13C and 13D and prevent the apparatus 2 from moving along the power line 1. This pause in movement provides self-regulating motion to ensure that any remaining accumulated ice is removed by giving additional time for the heater 11 and chisel 10 to operate. The apparatus 2 continues forward motion once movement of the balance wheel 13A, 13B, 13C and 13D becomes unblocked.

The balance wheels 13A, 13B, 13C and 13D are compressed spring loaded in order to apply upward pressure onto the power line 1, thereby ensuring that drive wheels 7A retain the device against the power line 1 and have adequate traction to drive the apparatus 2. When the cover 4 is open, the balance wheels 13A, 13B, 13C and 13D are out of the channel 9 so the apparatus 2 can be installed over the power line 1. Once the apparatus 2 is installed over the power line 1, the cover 4 can be closed and the balance wheels 13A, 13B, 13C and 13D pull the apparatus 2 downwards against the power line 1.

In another embodiment of the subject invention, safety guards (not shown) may be placed around the power line 1 in hollow traverse channel 9, provide additional guidance to the apparatus 2.

In another embodiment of the subject invention, the apparatus 2 further includes an electronics system 12 which contains power regulators for transformers 5, an internal programmable microprocessor, a control program and hardware for analog and digital circuitry. In one embodiment of the subject invention, the electronics system 12 may comprise an exterior user interface for updates and maintenance to the apparatus. In another embodiment the electronics system 12 may include the ability to communicate status information and receive commands by using a signal superimposed on the power line 1 or my means of wireless or infrared signals.

The functions of the electronics system 12 are to:
1. Regulate power from transformers 5 based on the following modes of operation:
   a) Stand-by Mode;
   b) De-icing Mode; and
   c) Test Mode (Externally controlled).
2. Process information from the encoder 8, the end-of-line sensors 18, the temperature sensor 14, the ice sensor 15, the line spacer detectors 21a and 21b, and signals from a remote control (not shown) to make decisions regarding deicing or test operation.
3. Perform an operational self-check of the apparatus 2 on a routine basis and/or when commanded remotely by a user.

The ice sensor 14 is a small hollow metal rod mounted horizontally above and outside the housing 3 to avoid any interference from ice or snow on the housing 3. The rod is supported by a weight-sensitive micro-switch. When a designated weight limit of ice accumulates on the rod, the micro-switch will be turned “ON” which sends an electrical signal to the electronics system 12. The electronics system 12 will confirm that ice has formed on the ice sensor 14 and then activate the de-icing operation of apparatus 2. The rod is shaped such that dry snow or rain will not accumulate on it; only ice or wet snow will accumulate on the rod. Additional embodiments of the apparatus may use contact or non-contact devices that rely on thermal, mechanical, ultrasonic or optical sensors or methods to measure the ice thickness or weight. It will be understood that the sensors could be implemented with a variety of sensing technologies for a variety of ambient conditions. All such variations come within the spirit and scope of the present invention.

After the electronics system 12 has activated the de-icing operation of apparatus 2, it will turn on a small heating element inside ice sensor 14 to melt off the ice attached to the rod, whereupon the micro-switch returns to “OFF”. Once the heater inside the rod is turned OFF, the low mass rod will quickly cool off to the ambient temperature and start to accumulate ice again. The apparatus 2 will travel, at least once, from one end of the power line 1 to the other end of the power line 1 (between two poles or towers where the power line is supported by insulating brackets) performing the de-icing operation. Once the apparatus 2 reaches the opposite end of power line 1, the electronics system 12 will again check for ice on the ice sensor 14. When additional deicing is not required, the apparatus 2 will return to stand-by mode at either end of the power line 1 or at whatever position has been selected for installation of an end-of-line stopper 19.

A temperature sensor 15 is mounted on top of the apparatus 2 on a corner of housing 3. This placement of the temperature sensor 15 prevents a misreading of the temperature due to snow cover or heat generated from the heaters 11 of apparatus 2. In one embodiment of the subject invention, the temperature sensor 15 may contain a transducer that generates an analog voltage at the rate of 10 mV/C, starting with 750 mV at 25C, or any equivalent temperature sensors. This voltage is sent to the electronics system 12. In another embodiment of the subject invention, the temperature sensors may include, but are not limited to infrared, optical pyrometer, fiber optic thermometer, an acoustic meter, an ultrasonic meter, thermocouples, bimetallic elements, temperature probes, or a heat sensor. It will be understood that the sensors could be implemented with a variety of sensing technologies for a variety of ambient conditions. All such variations come within the spirit and scope of the present invention.

The apparatus 2 also contains end-of-line sensors 18 that are micro-switches at either end of the apparatus 2. The end-of-line sensors 18 are located immediately above the heater 11 so that they won't freeze or be covered with snow once the apparatus has started. When the apparatus 2 comes close to an end-of-line stopper 19, the end-of-line sensor 18 will contact or detect the end-of-line stopper 19 and send a signal to the electronics system 12 to stop the motor 7 and the drive wheels 7A, thus stopping the motion of the apparatus 2 on the power line 1. In other embodiments of the subject invention, the end-of-line sensors 18 may be contact or non-contact sensors for detecting the presence of ice or another physical object located on the power line 1. In another embodiment of the subject invention, the end-of-line sensors 18 may include, but are not limited to pressure, ultrasonic, electromagnetic, or optical sensors. It will be understood that the sensors could be implemented with a variety of sensing technologies for a variety of ambient conditions. All such variations come within the spirit and scope of the present invention.

In one embodiment of the subject invention, the end-of-line stoppers 19 are two round pieces of metal or other hard materials with a hole and some flanges in the center that are attached to the power line 1. In one embodiment of the subject invention, the end-of-line stoppers 19 may be added to the power line 1 to dictate a pre-determined length of power line 1 that the apparatus 2 may act upon.

In another embodiment of the subject invention, the apparatus comprises two or more line spacer detectors 21a and 21b which send signals to the electronics system 12 to open and close the half covers of cover 4 when the apparatus 2 approaches and goes over a line spacer on power line 1. The line spacer detectors 21a and 21b may comprise a motion sensor selected from the group consisting of ultrasonic, optical, microwave, and video motion detectors. It will be understood that the detectors could be implemented with a variety of sensing technologies for a variety of ambient conditions. All such variations come within the spirit and scope of the present invention.

In an alternative embodiment of the subject invention, if the apparatus 2 is installed on an unpowered line to de-ice it, all of the electrical components of the subject invention may be connected to a rechargeable battery (not shown). Such an embodiment will also include, either in the apparatus 2 or as a separate docking station (not shown), a power supply suitable for recharging the battery. This supply may use conventional AC power derived from sources near the power line or may use a solar power source.

The apparatus 2 may also contain heat shields 20 over the heaters 11 to limit the heat transfer to components near the heaters 11. In another embodiment of the subject invention, ice shields (not shown) may be placed in the area of each chisel 10, vertical and perpendicular to the power line 1 to prevent shattered ice from coming in contact with the heaters 11.

Installation of the Apparatus:

Apparatus 2 may be installed onto the power line 1 without power interruption. The apparatus 2 can be installed by helicopters or trained personnel from an electrically safe distance when in an open position via a non-conducting installation rod with two fork fingers inserting into the two ears 3A. The apparatus can move in either direction, therefore it should be installed such that the cover 4 is opened outwards, away from any adjacent power lines in multiple power line bundles.

Operation of the Apparatus:

The apparatus of the subject invention is designed to keep a power line 1 from accumulating potentially damaging amounts of ice during certain meteorological conditions. When not in use, the apparatus 2 remains in a low power state to minimize power consumption and to prevent wear and tear on the apparatus 2.

The electronics system 12 of the apparatus 2 determines the directions and modes and of operation. The three (3) modes of operation of the apparatus are as follows:
a) Stand-by Mode;
b) De-icing Mode; and
c) Test Mode (Remotely controlled).

When the apparatus 2 is first installed on the power line 1, the transformers 5 use the power line 1 as their primary windings to generate electrical power for the apparatus 2. In the open position for installation when the “I” cores 5B are not in contact with the “U” cores 5A, the transformers 5 generate little power. This should be adequate to close the two half covers 4. In another embodiment, an external, removable 12V DC power source can be used temporarily to close the covers 4 and complete the installation.

In Stand-by mode, the apparatus 2 is at rest with drive motors 7, heaters 11 and chisels 10 idle. Power consumption is minimized such that only the sensors and the electronics system 12 are active. The electronics system 12 monitors the sensors and performs housekeeping functions such as monitoring any communications and checking the status of the apparatus 2.

The apparatus 2 always monitors the local ambient temperature and will continuously search for ice once the temperature falls below 35° F. When the temperature sensor 15 detects a local temperature below 35° F., the apparatus 2 will begin checking for ice formed on the ice sensor 14. When a designated amount of ice accumulates, the ice sensor 14 will send a signal to the electronics system 12. The electronics system 12 then activates the de-icing operation of apparatus 2. The electronics system 12 is responsible for discriminating between an icing triggering signal and any signals arising from animals, wind vibrations or other sources.

Before the apparatus 2 even begins to move along the power line 1, the heaters 11 and chisel 10 in the given direction will start operating using power generated from the main transformers 5. Shortly thereafter, motor 7 starts and provides rotating force to the drive wheels 7A to move the apparatus 2 along the power line 1. The apparatus 2 will move at its own pace based on how fast it can clear the ice on the power line 1. If, for any reason, the apparatus 2 becomes stuck in one place for an excessive amount of time, it will reverse direction, going back and forth to clear the obstacle.

In other embodiments of the subject invention, variations in the size and shape of the apparatus may be incorporated to allow it to be used on different power lines based on their diameters, nominal currents, distance in cable span, number of power lines in a bundle and local climate.

In one embodiment of the subject invention, once the apparatus 2 reaches one of the end-of-line stoppers 19 it docks in “stand-by” or “power-save” mode. The two end-of-line stoppers 19 are located near each of the adjacent towers or posts used to support the power line 1. In another embodiment of the subject invention, the apparatus 2 travels at least once from one end of the power line 1 to the other end in the de-icing mode and then determines if more de-icing is needed or if it enters Stand-by mode. The apparatus 2 can go in either direction to cover the power line span between the two adjacent towers or posts. In another embodiment of the subject invention, the end-of-line stoppers 19 can be located at any location between towers or posts. This is useful when the apparatus is operating on very long spans of power lines with more than one apparatus or to allow the apparatus to work around a permanent fixture attached to the power line.

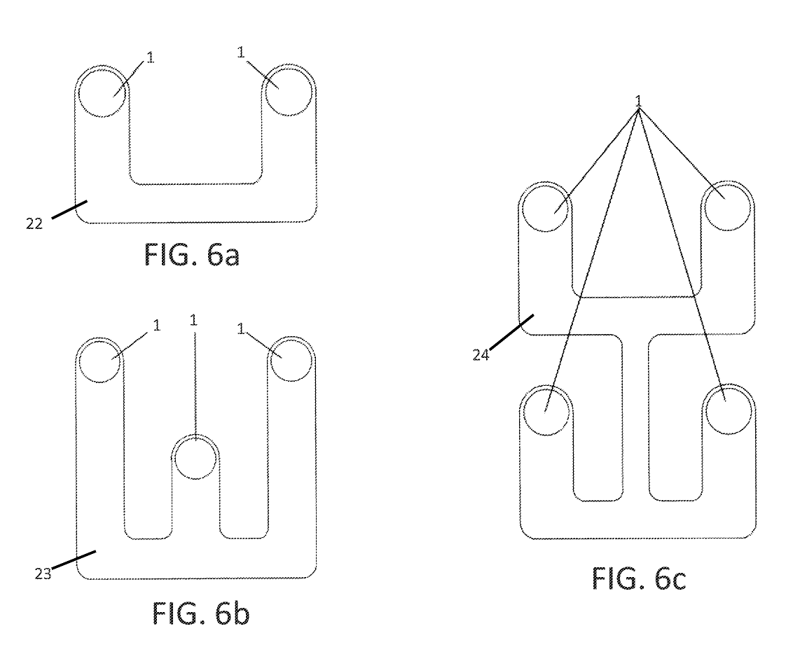

Various power lines may contain power line spacers. FIG. 6a illustrates a line spacer 22 for a double power line bundle. FIG. 6b illustrates a line spacer 23 for a triple power line bundle. FIG. 6c illustrates a line spacer 24 for a quadruple power line bundle. During the de-icing operation, if the apparatus approaches a line spacer 22, 23 or 24, the first line spacer detector 21a will send a signal to the electronics system 12 to activate the first cover motor 17a to open the first half of cover 4. This process will move the first set of balance wheels 13a and 13b, the first “I” core 5B of the first transformer 5 out of channel 9 and clear the way for the line spacer 22, 23 or 24 to pass through the apparatus. Once the line spacer 22, 23 or 24 has passed the first set of balance wheels 13a and 13b, the spacer detector 21a will send another signal to the electronics system 12 to activate the first cover motor 17a to close the first half of cover 4 and put all components back to their original positions. Very soon afterwards, the line spacer 22, 23 or 24 will approach the second set of balance wheels 13c and 13d. The second spacer detector 21b will send a signal to the electronics system 12 to activate the second cover motor 17b to open the second half of cover 4. This process will move the second set of balance wheels 13c and 13d, the second “I” core 5B of the second transformer 5 out of the channel 9 and clear the way for the line spacer 22, 23 or 24 to go by. Once the line spacer 22, 23, or 24 has passed the second set of balance wheels 13c and 13d, the second spacer detector 21b will send another signal to the electronics system 12 to activate the second cover motor 17b to close the second half of cover 4 and put all components back to their original positions.

The final mode of operation, the Test mode, is initiated by a user of the apparatus through input of an external signal to the electronics system 12 to test the various operations of the apparatus. The power maintenance company can remotely test the apparatus at any time to make sure it is operational for the next ice storm. During the test, the apparatus will perform a complete self-test for some predetermined period of time and then return to a stand-by mode.

What is claimed is:

1. An apparatus for de-icing a hanging power line, the apparatus comprising: a housing comprising a first opening and a second opening, wherein the housing is placed over the power line such that a portion of the power line is contained within the housing and extends through both openings; a means for moving the housing in either direction along the power line; a first heating element proximate to the first opening, wherein the first heating element generates sufficient heat to the external surface of the power line proximate to the first opening to substantially melt the layer of ice attached to the external surface of the power line; a first chisel member proximate to the first opening, wherein the first chisel member removes ice with the substantially melted attached layer from the power line; a second heating element proximate to the second opening; wherein the second heating element provides generates heat to the external surface of the power line proximate to the second opening to substantially melt the layer of ice attached to the external surface of the power line; a second chisel member proximate to the second opening, wherein the second chisel member removes ice with the substantially melted attached layer from the power line; and an electronics system disposed within the housing.

2. A method for de-icing a hanging power line comprising the steps of:
a) attaching an apparatus comprising a housing to the power line, wherein the power line extends through a first opening and a second opening on the housing;
b) generating electric power for the apparatus from electric current carried by the power line;
c) detecting an ambient temperature below 35° F.;
d) detecting ice formed on an ice sensor attached to the housing, wherein a pre-determined amount of ice formed sends an activating signal to an electronics system attached to the housing;
e) activating a first heating element attached to the housing proximate to the first opening, wherein the first heating element provides sufficient heat to the external surface of the power line proximate to the first opening to substantially melt the layer of ice attached to the external surface of the power line;
f) activating a first chisel member attached to the housing proximate to the first opening, wherein the first chisel member removes ice with the substantially melted attached layer from the power line;
g) activating a means for moving the apparatus in a first direction such that the first opening moves substantially forward along the power line and the second opening moves substantially backward along the power line, further wherein the first heating element and the first chisel member are operating in the first direction to remove ice from the power line;
h) detecting a first stop member with a first proximity sensor attached to the housing;
i) de-activating the means for moving the apparatus in the first direction, the first heating element and the first chisel member;
j) activating a second heating element attached to the housing proximate to the second opening, wherein the second heating element provides sufficient heat to the external surface of the power line proximate to the second opening to substantially melt the layer of ice attached to the external surface of the power line;
k) activating a second chisel member attached to the housing proximate to the second opening, wherein the second chisel member removes ice with the substantially melted attached layer from the power line;
l) activating a means for moving the apparatus in a second direction such that the second opening moves substantially forward along the power line and the first opening moves substantially backward along the power line, further wherein the second heating element and the second chisel member are operating in the second direction to remove ice from the power line;
m) detecting a second stop member a second proximity sensor attached to the housing;
n) de-activating the means for moving the apparatus in the second direction, the second heating element and the second chisel member; and
o) repeating steps e) through i) above if ice is detected on the ice sensor, otherwise docking at the second stop member if no ice is detected.

3. The apparatus of claim 1, wherein the housing is connected over the hanging power line without disconnecting the power line.

4. The method of claim 2, wherein the housing is connected over the hanging power line without disconnecting the power line.

5. The apparatus of claim 1, wherein the housing further comprises a two half covers over the contained power line, wherein the half covers are substantially equivalent in size and shape.

6. The apparatus of claim 1, wherein the housing contains the power line in an internal hollow channel that comprises an inverted substantially U shaped configuration.

7. The apparatus of claim 1, further comprising a motion sensor contained within the housing, wherein the motion sensor detects movement along the power line.

8. The motion sensor of claim 7, wherein the motion sensor comprises an optical encoder.

9. The motion sensor of claim 7, wherein the motion sensor is selected from the group consisting of ultrasonic, optical, microwave, and video motion detectors.

10. The apparatus of claim 1, further comprising additional rotatable wheels that engage the power line within the housing and move along the power line.

11. The apparatus of claim 1, further comprising at least two stop members affixed to the power line that delineate the range of travel for the apparatus along the power line.

12. The method of claim 2, wherein the first proximity sensor and the second proximity sensor are selected from the group consisting of pressure, ultrasonic, electromagnetic and optical sensors.

13. The apparatus of claim 1, wherein the housing further comprises a first proximity sensor and a second proximity sensor selected from the group consisting of pressure, ultrasonic, electromagnetic and optical sensors.

14. The apparatus of claim 1, wherein the housing further comprises a temperature sensor selected from the group consisting of infrared, optical pyrometer, fiber optic thermometer, an acoustic meter, an ultrasonic meter, thermocouples, bimetallic elements, temperature probes and a heat sensor.

15. An apparatus for de-icing a power line, the apparatus comprising: a hollow housing comprising two openings, wherein the housing is placed over the power line such that a portion of the power line is contained within the housing and extends through both openings; a means for moving the housing in either direction along the power line; a motor operably connected to the means for moving the housing; a temperature sensor attached to the housing; an ice sensor attached to the housing; a first heating element and a first proximity sensor disposed on the housing proximate to one of the openings; a second heating element and a second proximity sensor disposed on the housing proximate to the other opening; and an electronics system disposed within the housing.
